(19) United States
(12) Patent Application Publication
(10) Pub. No.: US 2006/0249293 A1
(43) Pub. Date: Nov. 9, 2006

(54) Front-end loader finish grading apparatus

(76) Inventor: Frank Stanaland Christian, Quitman, GA (US)

Correspondence Address: FRANK STANALAND CHRISTIAN, JR., 715 ELLENBERG RD., QUITMAN, GA, 31643, US

(21) Appl. No.: 11/120,597

(22) Filed: May 3, 2005

(51) Int. Cl. A01B 31/00

(52) U.S. Cl. 172/684.5

(57) ABSTRACT

An attachment apparatus, which represents a reconfiguration and redesign of the traditional box blade, to enable a front-end loader type machine to finish grade a land surface having a cutting edge or blade, a rigid frame, a method of attachment of rigid frame to a given front-end loader, such as a skid-steer loader, a pair of gauge wheels attached to the rigid frame just before the cutting edge, which are able to move vertically under variable tension between two limiting positions, whose exact location and resistance is either fixed or adjustable manually. To achieve its purpose the apparatus has been designed to correlate the physics of a “forward moving, pushing and lifting machine” with the requirements of the grading process and thereby extend the traditionally limited use of a front-end loader machine into the finish grading market.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of finish land grading and more specifically to an apparatus for loosening, moving and finish grading a surface with a front-end loader style machine and making use of a pair of variably resistant gauge wheels whose range of resistance and range of movement are manually adjustable. When one considers the goal of the grading process and the characteristics of the conventional tractor and box blade, it is little wonder that the conventional tractor and box blade have been the instrument of choice over the last forty years or so to accomplish this process. For the grading involves “resurfacing” a given area or mass of material. More specifically, this resurfacing means “averaging” a given terrain, i.e. cutting down high places and filling in low places. Even when a perfectly flat surface is desired, say, for construction purposes where a structure will be located, this means in grading terms that a surface will be created whose “average departure” from an external reference or grade will be reduced as close as possible to zero.

In order to resurface an area, however, an instrument is needed to loosen, gather, move and finally redistribute or level the ground material. Such an instrument must have a cutting edge or blade that can be finely controlled in relation to the surface to be graded, and this means a cutting edge or blade that can be controlled somewhat independently of the machine and the terrain that is being graded.

Now, in light of these considerations and for any number of reasons based upon them the traditional tractor has been the logical choice for the finish grading process. For to begin, since its start as an agricultural tool to replace the labor of animals, the conventional tractor has always been a “pulling or dragging” machine, whether the implement being pulled was a set of harrows, a plow, a trailer or a blade for grading. Secondly, given the fact that the tractor has always ridden “ahead” of its implement means that the tractor by means of its lift arms has formed a natural counteraction to the tendency of a blade to dig and has forced the blade to follow the ground, which is integral to the grading process. Thirdly, the semi-flexible linkage of the three-point hitch has given the implement a certain independence from the machine, which is also required for grading. And finally, the draft control system on modern tractors has given the operator further control of the depth to which the blade can dig and greatly increased the grading dynamics of the machine.

The implement known throughout the industry as the “box blade”, on the other hand, is the implement which has been perfectly suited to “loosen, gather, move and relevel” a given surface. For the box blade developed from the straight blade (which is still in use today), when the box blade was given sides. This facilitated the blade holding material in front of it so that it could be redistributed. Furthermore, the box blade evolved even further when a row of scarifier teeth was located just ahead of the sides of the implement and the blade to enable the surface to be loosened before it was gathered and redistributed.

In short, because of its grading ability, the standard tractor and box blade can still be seen around most construction sites at one point or another, even though there is very little else that the tractor can contribute to the construction process. In relation to construction, it is virtually a one-dimensional machine with grading being its primary and almost sole use, a rather expensive investment for such a limited use, given the versatility that is being demanded of equipment today.

The skid-steer loader, on the other hand, or front-end loader generally, from its beginning developed with a different purpose and function. For from its inception the skid-steer loader has been primarily a “pushing, digging, lifting, moving and loading” machine. This is why the skid-steer loader has always come standard with a bucket as its primary attachment. And even though the use of hydraulics has greatly expanded the many uses and functions of the skid-steer loader, from the almost countless attachments on the market, still finish grade work can hardly be accomplished by the skid-steer loader given some of its physical characteristics.

The forward motion of the machine and direction of its work, for example, means that the skid-steer loader is a pushing rather than a pulling machine and this alone makes it almost impossible for a skid-steer to control the action of a blade in relation to the ground, at least with any degree of accuracy. For either the blade begins to dig excessively or rides above the ground and becomes inoperable, neither of which serves the grading process. Furthermore, the short wheel base of the machine gives it an erratic movement over rough terrain which obviously complicates resurfacing an area. And then there is the rigid rather than semi-independent connection between the skid-steer loader and its attachments, which must be compensated for somehow if grading is to take place. All in all, it is little wonder that the skid-steer loader generally sits idle when fine grading is needed, even though the other tasks which the machine can be called on to perform are now almost limitless, and growing everyday.

To solve this inability of the skid-steer to grade, some have resorted to controlling the blade by some outside means, such as expensive laser guided systems, etc. Others have sacrificed the “dirt moving” function needed for grading to merely pulverizing the surface through rotating drums with fixed teeth. And perhaps there are other methods and means that have been tried to produce a finely graded surface with the skid-steer loader. But the problem with these methods, apart from cost, in some cases, is the fact that the skid-steer loader is generally not called upon to “grade open roads” but to work in close proximity to buildings and structures, etc. after the manner of a traditional tractor and box blade. It means also that it must be able to reform the depth and contours of the surface, as well as create a “landscape ready” constituency.

In light of these limitations the inventor set for himself the task of reconfiguring and redesigning the traditional box blade, adding whatever non-traditional elements were needed, to make it, first and foremost, a pushable rather than a pullable implement, so that it could be used by a front-end loader style machine in its most natural direction, moving forward rather than backwards. The purpose here was to enable the skid-steer or front-end loader to resurface a given area well enough to compete with the traditional tractor. Secondly, the inventor was intent on the implement preserving all the traditional functions of the box blade, of loosening and gathering material, as well as redistributing and leveling it. Thirdly, the inventor was intent on designing an implement that would have no other external or automatic or powered means controlling the blade other than the electronics and hydraulics of the loader under the operator's control or the influence of the terrain being graded. Finally, the inventor set for himself the goal of designing a relatively inexpensive but practical implement that would be durable and not vulnerable to weather or other factors, and all of this by analysing the requirements of the grading process and the characteristics of the front-end loader style machine and bringing the dynamics of the two into as close a relationship as possible. The result is the invention which is here disclosed.

### BRIEF SUMMARY OF THE INVENTION

The primary object of the invention is to reconfigure and redesign the traditional box blade so that it is pushable rather than pullable.

Another object of the invention is to maintain all functions of a traditional box blade of loosening, gathering and moving and leveling dirt or material.

Another object of the invention is to design a box blade specifically for a skid-steer loader but which may be used on any front-end loader.

A further object of the invention is to design a box blade that grades when skid-steer loader is moving in forward direction because of visibility.

Yet another object of the invention is to expand the versatility of a skid-steer loader and reduce the need for a conventional tractor for grading.

Still yet another object of the invention is to create a box blade that is economical and does not rely on expensive external laser guidance systems, etc.

Another object of the invention is to create a box blade that relies exclusively on the dexterity of the operator and the internal electronics and hydraulics of the machine.

Another object of the invention is to create a blade for grading that uses the ground as a support or stabilizer for the blade.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an attachment apparatus, which represents a reconfiguration and redesign of the traditional box blade, to enable a front-end loader type machine to finish grade a land surface, comprising: a cutting edge or blade attached to a rigid frame and set at a right angle to the central axis of the machine, the front of said cutting edge facing away from the front of the loader machine, said cutting edge set at a distance far enough ahead of the loader machine such that operator can see the bottom of the cutting edge from the rear,

In accordance with a preferred embodiment of the invention, there is disclosed an attachment apparatus for a front-end loader style machine, comprising: a method or means of attachment of the rigid frame and cutting edge to a front-end loader style machine as required by the individual type of loader and mounted on the rear of the rear cross panel,

In accordance with a preferred embodiment of the invention, there is disclosed an attachment apparatus to enable a front-end loader style machine to finish grade a land surface, comprising: a pair of gauge wheels set immediately in front of the cutting edge and attached to the sides of the rigid frame, said gauge wheels able to slide or move vertically, said gauge wheels subject to variable tension between two limiting positions, a start position of least but adjustable tension up to an end position of maximum tension produced by a vertically adjustable stop.

In accordance with a preferred embodiment of the invention, there is disclosed an attachment apparatus to enable a front-end loader style machine to finish grade a land surface, comprising: a row of scarifier teeth set in a rigid cross member and located before the sides of the rigid frame and cutting edge, said scarifier teeth being individually adjustable or individually removeable or said teeth as a whole able to be made inoperable.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an overall plan view of the implement

FIG. 2 is a front to rear perspectival view

FIG. 3 is a gauge wheel close-up

FIG. 4 is a rear perspectival view

FIG. 5 is a tooth bar and teeth perspectival view

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Land grading and leveling implements have been around for years, which use a cutting edge or blade, a hardened and curved piece of metal specially molded, to slice or scrape the ground when it is pulled or pushed under pressure. The most commonly used cutting edge for finish grading work around construction sites because of limitations of space is the traditional box blade, which has been the instrument of choice to resurface and finish an area. The box blade began as an open straight blade and first became the box blade that we know when the cutting edge was enclosed with sides to facilitate holding and moving material in front of the blade. To these sides was added a row of scarifier teeth which were located between the machine and the blade to loosen the ground before it is gathered and leveled by the blade. However effective and unsurpassed the box blade has been as a finish grade implement where space is limited, it can only be “dragged or pulled” behind a conventional tractor, which in turn can hardly be used for any other purpose in the construction setting. Any attempt to use the traditional box blade on a more versatile machine, such as the skid-steer loader or front-end loader, runs not only counter to the dynamics of the machine but the dynamics of the implement's design as well.

Those cutting edges attached to other machines, such as the bulldozer or motorgrader, more readily found on the construction site, are faced with other limitations when finish grade work is the goal. The blade of the bulldozer, which is the “pushing machine” par excellence, can move large quantities of material, to be sure, but could hardly be used to finish grade a given terrain. Rather, at best it can be used to “rough-in” the elevations of the terrain as needed. The size of the blade of the bulldozer, coupled with the rigid connection between machine and blade, plus the lack of a vertical curl function of the blade (the blade is always perpendicular to the plane of the machine) all contribute to the cutting edge's inability to respond to the terrain even partially independently of the machine.

The motorgrader, on the other hand, which is the “grading machine” par excellence, is faced with other limitations. For the cutting edge of the motorgrader is located towards the center of the machine. In this way the motorgrader is able to “average” or resurface an area given its terrain sensitive wheels and axles,etc. However, given the location of its blade, as well as its length and size, the motorgrader is designed for use on roads or in open areas and not in close proximity to buildings or structures. Not only this but the fact that the motorgrader has no enclosed blade like the box blade means that it is used more to resurface an area than to move quantities of material and carefully place them, which is an integral part of the grading process.

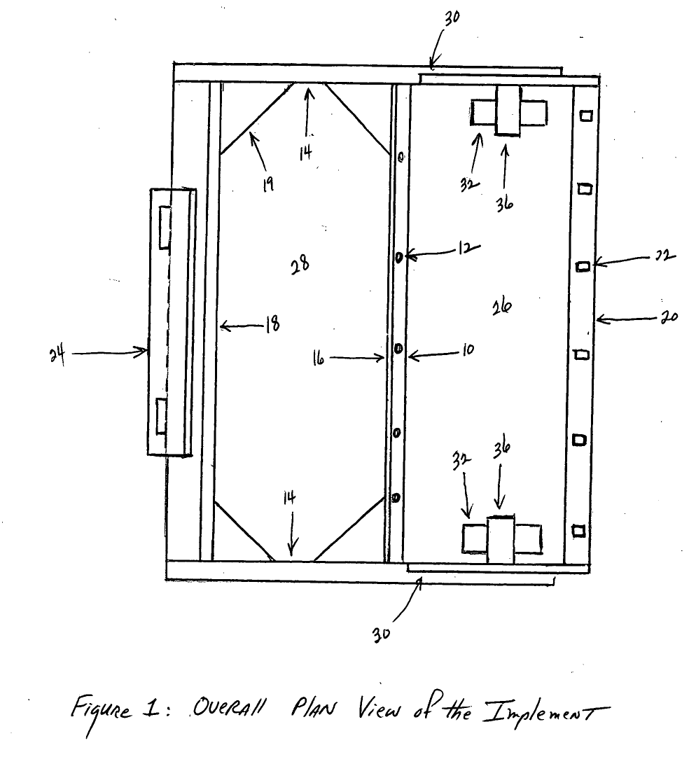

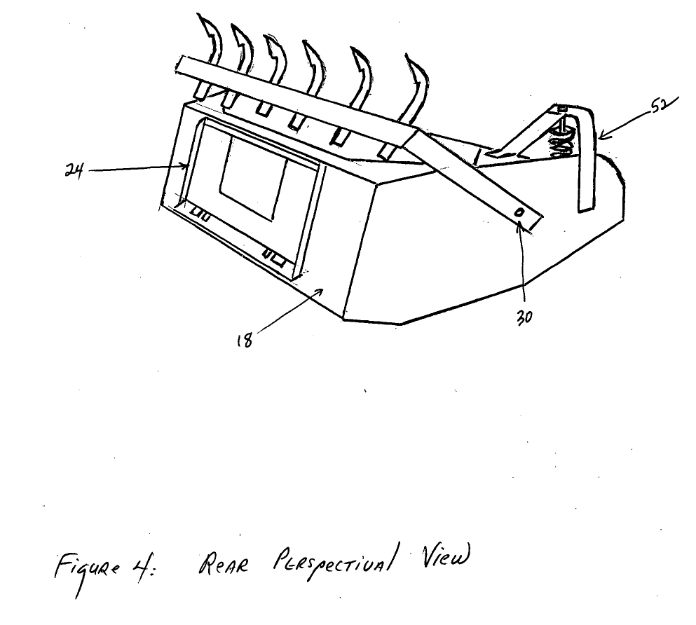

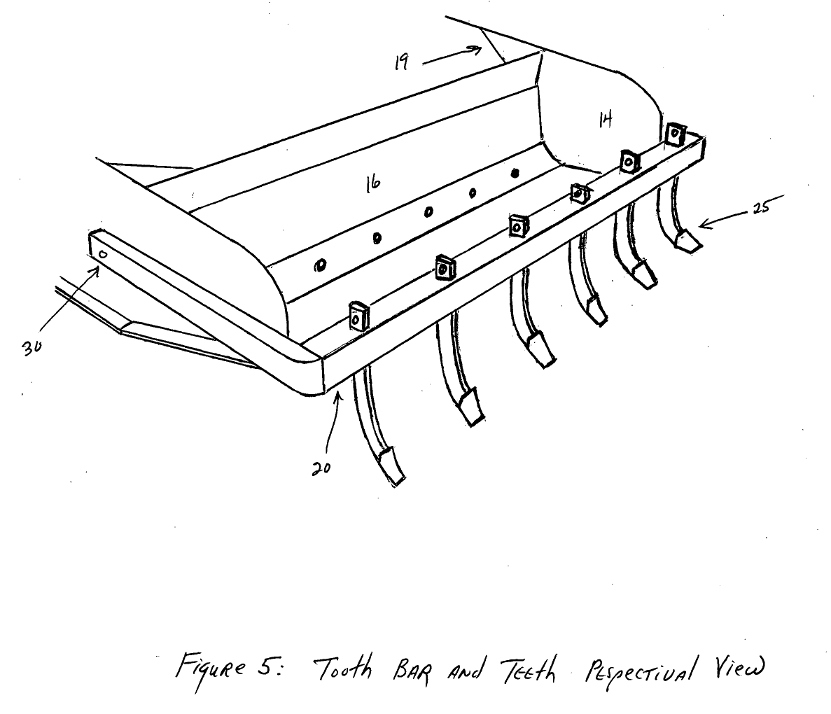

A box blade, therefore, or the “grading implement” par excellence, which could be used effectively on a skid-steer loader, which is fast becoming the “versatile machine” par excellence, because of its many attachments, would seem to be the perfect combination of implement and machine. The invention pictured in FIGS. 1-5 disclose such an apparatus or device which represents first and foremost a reconfiguration or redesign of the traditional box blade for use on a “pushing and lifting” type machine, and secondly, the addition of those elements to the traditional design necessary to accommodate the physics of “pushing” rather than “pulling” a cutting edge in a forward direction.

The cutting edge 10 in FIG. 1 is attached to a cross panel 16, which is a component comprising the rigid frame of the implement, and set at a right angle to the central axis of the machine. Further, said cutting edge 10 is facing away from the machine, which is used to move the implement. The rigid cross member 20 or tooth bar is positioned when in use before the cutting edge to loosen the soil. The means of attachment 24 to the loader style machine is attached to the rear of the rear cross panel 18. When the cutting edge 10 and front cross panel are positioned at a distance ahead of the rear cross panel 18 sufficiently that the bottom of the cutting edge 10 can be seen from the rear by the operator, and connected to the said rear cross panel 18 by means of two parallel sides 14, an enclosed space 28 is produced which enables the cutting edge to gather material behind itself when the invention is pulled backwards by the loader in reverse direction. When these same sides 14 are extended ahead of the cutting edge far enough to support the tooth cross bar 20 and then some, a second space 26 is created, which is the more important one, as it enables the cutting edge to collect material in front of itself when the invention is moving forward. Thus, three functions of the traditional blade are preserved for a loader style machine, of loosening, gathering and moving, and leveling a given terrain.

Controlling a cutting edge (which “digs or cuts” naturally) in relation to the surface of the ground, when it is pushed in the direction of its molded surface from the rear, is virtually impossible with any degree of accuracy because of the weight of the implement and the typically rigid connection between the implement and machine. For there is no other counterforce to this digging tendency than that provided by the machine itself, which tends to make changes after the fact and in larger increments. To provide a counterforce to this digging tendency of the blade, the invention has been fitted in its preferred embodiment with a pair of gauge wheels 32 mounted to the sides of the frame 14 ahead of the cutting edge. These gauge wheels 32 are the key to the effective operation of the invention, for they serve several indispensable functions.

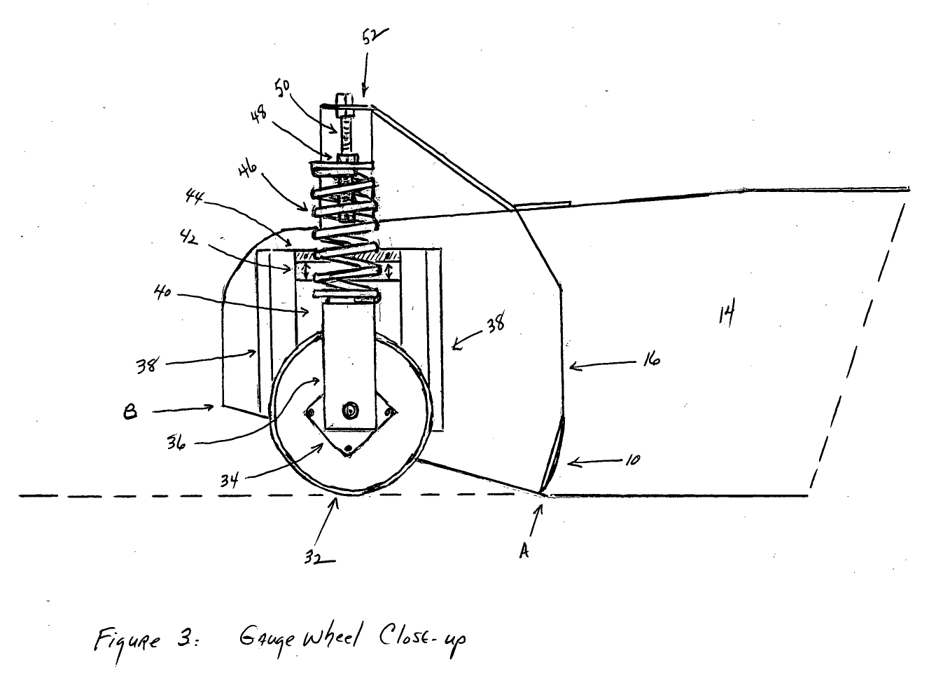

First, as can be seen in FIG. 3, the sides 14 of the invention, beginning at the cutting edge, are shaped in such a way as to form an angle upwards away from the ground from point A to B. This angle means that when the rear of the implement 24 in FIG. 1, where it is attached to the loader, is raised above the ground with the cutting edge 10 still on the ground, the implement will first begin to pivot around the cutting edge like a lever and then if the process continues, it will begin to pivot around the wheels 32 if they are touching the ground. As the implement is rotated around the gauge wheels 32 the cutting edge 10 is raised or lowered in relation to the surface of the ground. By functioning like the fulcrum of a lever the gauge wheels 32 enable the operator to establish three distinct blade positions relative to the ground: either the blade can be lifted above the ground and made inoperable or made even with the ground, or lowered below the ground if the wheels 32 move to a higher position. This is the first function of the gauge wheels, as a pivot or fulcrum of the lever represented by the implement, to control the blade attached to the lever.

Secondly, from FIG. 3 it will be seen that the gauge wheels 32 of the implement are not rigidly mounted to the sides 14 but in a carefully prescribed fashion. The wheels are able to move vertically to a certain extent when the backplate 40 slides up and down between the side tracks 38. When the wheels (set in brackets 36 attached to backplate 40) begin to slide upwards, the spring 46 resists this movement and increases in tension, because the top of the spring is resisted by the top bracket 52 attached to the sides of the implement 14. The tension applied to the wheels can be increased or decreased by using the nut 48 on threaded rod 50.

Now, the vertical movement of the gauge wheels 32 is bounded at the lower end by a fixed stop set such that in this position the bottom of the wheels are even with the bottom of the cutting edge when the invention is resting on a flat surface unattached to any machine. This means that when the invention is raised at the rear and pivoted around the wheels, the wheels begin to slide upwards under tension. At the upper end, on the other hand, the vertical movement is limited by an external stop 44, which is adjustable vertically and manually, increasing or decreasing the space 42 available for movement.

The second and most important function of the vertically moveable and variably resistant gauge wheels can now be explained. The wheels ride on the ground which transmits a counterforce to the cutting edge's digging tendency. Thus, the wheels function to “support” the blade when it is grading. Only, the wheels are not the sole support of the blade but rather share this support with the loader arms which can raise or lower the front of the invention in two possible ways: through its lift or through its curl functions. This means that the loader under the control of the operator can override the upward force of the wheels, say, to cut or dig a high spot forcing the wheels upward and the blade downward. When the cutting edge approaches a low spot that needs filling, the loader will continue to support the cutting edge apart from the terrain while the wheels move downward to provide additional stability. Or should the cutting edge approach a steep incline in the terrain, too steep to dig or cut, the gauge wheels will rise to their highest position, encounter the external stop and at this point their resistance will become absolute. This means that the terrain by means of the wheels at this point will overpower the machine and force the cutting edge to follow the terrain upwards. Through this process of give and take between machine and terrain the cutting edge can be controlled to restructure a given surface, which represents a new plane which is neither the existing terrain nor the surface that the machine is riding upon.

The last and final function of the variably resistant and moveable wheels has to do with the travel space 42 which is visible to the operator of the machine. For this space provides feedback to the operator concerning the position of the blade relative to the ground, which is otherwise not visible. This plus the fact that the bottom edge of the cutting edge can be seen from the rear enhances the manual use of the blade by the operator.

In summary, the variably resistant and vertically moveable gauge wheels, which operate between two limiting positions of least and maximum tension, function for the invention as a “visible and variably moveable and resistant fulcrum” of a lever a) to establish and help maintain various blade positions relative to the ground, b) to support the blade independently of the machine when needed, c) to otherwise share support of the blade with the machine and act as a stabilizing force and d) to provide a reference point for information concerning what the terrain is doing and what the cutting edge in turn needs to do.

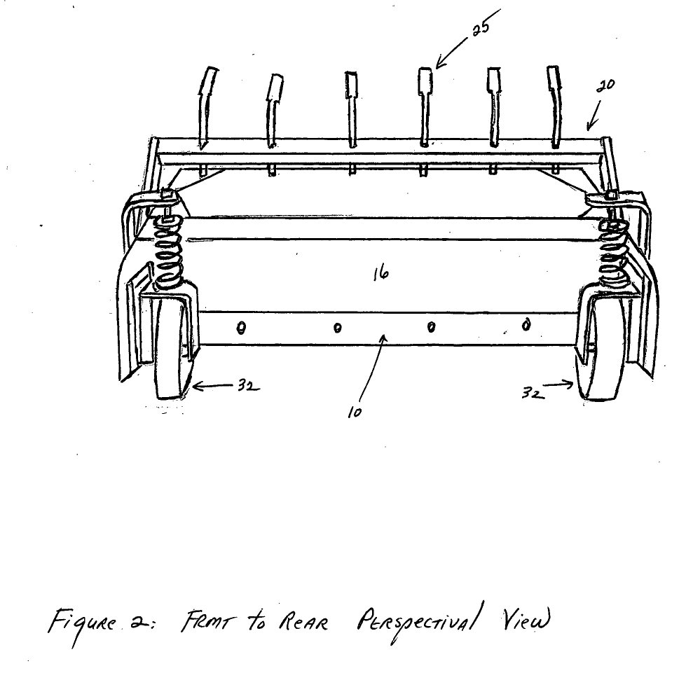

FIGS. 2, 4 and 5 show the invention from various angles with the tooth bar lifted and thus inoperable as well as with the tooth bar down and engaged. When one considers that by pivoting the implement from the rear about the wheels and forcing the wheels upward three blade positions can be established and considers that the tooth bar can either be engaged or not, five distinct operations of the implement by a front-end loader become possible: 1) the teeth can be engaged while the blade is lifted above the surface-this may be termed the “scarify only” operation, 2) the teeth can be engaged with the cutting edge even with the ground--this may be termed the “scarify and grade” operation, 3) the teeth can be engaged with the blade lowered below the surface—this may be called the “scarify and dig or doze” operation, 4) the teeth can be lifted out of the way and made inoperable with the blade even with the ground-this would be the “grade only” positon, and finally, 5) the teeth can be lifted while the blade is lowered below the surface—this becomes the “dig or doze only” operation. In light of these various operations the versatility of the invention should be obvious.

Concerning embodiments of the invention, the current configuration is the preferred one because all of the box blade functions are preserved from the rigid frame design and blade location. Although a pair of gauge wheels 32 have been used, any ground supports for the blade, such as skids, etc., would be also possible provided that they offer the same variably resistant and moveable supports as the wheels. Finally, the method of attachment that has been preferred is that which allows the invention to connect with the skid-steer loader, but any method that would connect the implement to a front-end loader style machine with both lift and curl functions can be used.

In conclusion, the front-end loader has never been a “finish grading instrument” because like other “pushing and lifting” machines the physics of the machine run counter to the requirements of grading. At the same time some methods which have been developed to facilitate grading in the forward direction have been costly and highly sophisticated rather than inexpensive and practical. By providing a manual and mechanical means for a loader to grade using only those forces exerted by the loader and/or terrain, the invention further enhances the usefulness of the front-end or skid-steer loader and increases its capacity to compete with the conventional tractor in the finish grade process.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An attachment apparatus, which represents a reconfiguration and redesign of the traditional box blade, to enable a front-end loader type machine to finish grade a land surface, comprising:
a cutting edge or blade attached to a rigid frame and set at a right angle to the central axis of the machine;
the front of said cutting edge facing away from the front of the loader machine;
said cutting edge set at a distance far enough ahead of the loader machine such that operator can see the bottom of the cutting edge from the rear;

2. said rigid frame, comprising:
a front panel perpendicular to the central axis of the machine to support the cutting edge;
two side panels extending ahead and behind the cutting edge and attached at right angles to the ends of the front cross panel such that two spaces are created, one in front of and one behind the cutting edge where material can be collected;
a rear cross panel parallel to the front cross panel completing the enclosure of the space behind the cutting edge;

3. An attachment apparatus for a front-end loader style machine, comprising:
a method or means of attachment of the rigid frame and cutting edge to a front-end loader style machine as required by the individual type of loader and mounted to the rear of the rear cross panel;

4. An attachment apparatus to enable a front-end loader style machine to finish grade a land surface, comprising:
a pair of ground supports or gauge wheels set immediately in front of the cutting edge and attached to the sides of the rigid frame;
said ground supports able to slide or move vertically;

5. said vertical movement of ground supports resisted by source of tension that is variable and increases as ground supports move upwards;
said vertical movement of ground supports operating between two limiting positions, a lowest position where bottom edge of ground supports are even with bottom edge of cutting edge and whose tension is manually adjustable, up to a highest position created by an external stop, whose exact location is also vertically and manually adjustable;

6. said vertical movement of ground supports being effected by no other external or automatic or powered means that the forces exerted by the loader style machine as transmitted through the lift and/or curl functions of the loader arms and/or the terrain supporting the ground supports.

7. An attachment apparatus to enable a front-end loader style machine to finish grade a land surface, comprising:
a row of scarifier teeth set in a rigid cross member and located before the sides of the rigid frame and cutting edge;
said scarifier teeth being individually adjustable vertically or removeable;

8. said row of scarifier teeth as a whole being liftable out of the way of cutting edge and made inoperable;
